(19) United States
(12) Patent Application Publication
(10) Pub. No.: US 2008/0290105 A1
(43) Pub. Date: Nov. 27, 2008

(54) Dispensing Closure, Closure and Container Package, and Method of Manufacture

(75) Inventor: Philip J. Robinson, Sylvania, OH (US)

Correspondence Address: REISING, ETHINGTON, BARNES, KISSELLE, P.C., P.O. BOX 4390, TROY, MI, 48099-4390, US

(73) Assignee: REXAM CLOSURE SYSTEMS INC., Perrysburg, OH (US)

(21) Appl. No.: 12/159,046

(22) PCT Filed: Apr. 23, 2007
(86) PCT No.: PCT/US07/09892

§ 371 Date: Jun. 24, 2008

(30) Foreign Application Priority Data
May 17, 2006 (US) 11436077

(51) Int. Cl. B65D 43/16; B65D 43/00; B65D 1/02; B29C 45/17

(52) U.S. Cl. 220/835; 220/796; 215/40; 264/242

(57) ABSTRACT

A dispensing closure includes a base (36) and a lid (40) of one-piece integrally molded plastic construction. The lid is hinged to the base for movement between an open position spaced from the base and a closed position overlying the base. The base has a deck (50) with an outer surface, a dispensing opening (58), a radially inwardly and axially outwardly facing conical surface (56) extending from the dispensing opening to the outer surface of the deck, and a radially outwardly facing first snap/seal bead (52) surrounding the deck adjacent to the outer surface. The lid has a pintle (68 or 86) for receipt in the dispensing opening, a wall (70) spaced radially outwardly from the pintle and a radially inwardly facing second snap/seal bead (72) on the wall for engagement with the first snap/seal bead on the base. The pintle on the lid is sufficiently long as compared to the surrounding wall on the lid to engage the conical surface and align the snap/seal beads as the lid is moved toward the closed position and the snap/seal beads are spaced from each other. The second snap/seal bead is received by sealing snap-fit over the first bead and the pintle preferably is spaced from the dispensing opening in the fully closed position of the lid.

The present disclosure relates to a dispensing closure, a dispensing closure and container package, and a method of closure manufacture in which the closure includes a base and a lid of one-piece plastic construction, and in which the lid is automatically aligned with the base as the lid is moved to its closed position over the base.

### BACKGROUND AND SUMMARY OF THE DISCLOSURE

Fluid dispensing closures typically include a one-piece integrally molded shell having a base and a lid connected by a hinge to the base to pivot between a closed position adjacent to the base and an open position spaced from the base. The base includes a dispensing opening through which product may be dispensed in the open position of the lid and through which dispensing is blocked in the closed position of the lid. U.S. Pat. Nos. 6,766,926 and 6,880,736 illustrate dispensing closures of this general type. A problem that can be encountered with dispensing closures of this type is that the lid can interfere with the base as the lid is moved toward its closed position. This problem readily can be overcome as the lid is closed manually by jockeying the lid with respect to the base, but can be problematic in applications in which the lid is closed over the base while the closure is within its forming mold. An object of the present disclosure is to provide a mechanism whereby the lid is automatically aligned with the base as the lid is moved toward its closed position.

The present disclosure embodies a number of aspects that can be implemented separately from or in combination with each other.

A dispensing closure in accordance with one aspect of the present disclosure includes a base and a lid of one-piece integrally molded plastic construction. The lid is hinged to the base for movement between an open position spaced from the base and a closed position overlying the base. The base has a deck with an outer surface, a dispensing opening, a radially inwardly and axially outwardly facing conical surface extending from the dispensing opening to the outer surface of the deck, and a radially outwardly facing first snap/seal bead surrounding the deck adjacent to the outer surface. The lid has a pintle for receipt in the dispensing opening, a wall spaced radially outwardly from the pintle and a radially inwardly facing second snap/seal bead on the wall for engagement with the first snap/seal bead on the base. The pintle on the lid is sufficiently long as compared to the surrounding wall on the lid to engage the conical surface and align the snap/seal beads as the lid is moved toward the closed position and the snap/seal beads are spaced from each other. The second snap/seal bead is received by sealing snap fit over the first bead and the pintle is spaced from the dispensing opening in the fully closed position of the lid.

### BRIEF DESCRIPTION OF THE DRAWINGS

The disclosure, together with additional objects, features, advantages and aspects thereof, will best be understood from the following description, the appended claims and the accompanying drawings, in which:

FIG. 1 is a fragmentary perspective view of a package in accordance with one exemplary embodiment of the present disclosure;

FIGS. 2 and 3 are fragmentary sectional views taken substantially along the respective lines 2-2 and 3-3 in FIG. 1;

FIG. 4 is a fragmentary sectional view on an enlarged scale of the portion of FIG. 3 within the area 4;

FIG. 5 is a top plan view of the dispensing closure in the package of FIGS. 1-4 as molded;

FIG. 6 is a sectional view taken substantially along the line 6-6 in FIG. 5;

FIG. 7 is a bottom plan view of the dispensing closure illustrated in FIGS. 5 and 6;

FIGS. 8 and 9 are fragmentary sectional views on enlarged scales of the portions of FIG. 6 within the respective areas 8 and 9;

FIG. 10 is a fragmentary perspective view of a package in accordance with another exemplary embodiment of the present disclosure;

FIGS. 11 and 12 are fragmentary sectional views taken substantially along the respective lines 11-11 and 12-12 in FIG. 10;

FIG. 13 is a fragmentary sectional view on an enlarged scale of the portion of FIG. 12 within the area 13;

FIG. 14 is a top plan view of the dispensing closure in the package of FIGS. 11-13 with the lid open as molded;

FIG. 15 is a sectional view taken substantially along the line 15-15 in FIG. 14;

FIG. 16 is a bottom plan view of the dispensing closure illustrated in FIGS. 14-15; and

FIGS. 17 and 18 are fragmentary sectional views on enlarged scales of the portions of FIG. 15 within the respective areas 17 and 18.

### DETAILED DESCRIPTION OF PREFERRED EMBODIMENTS

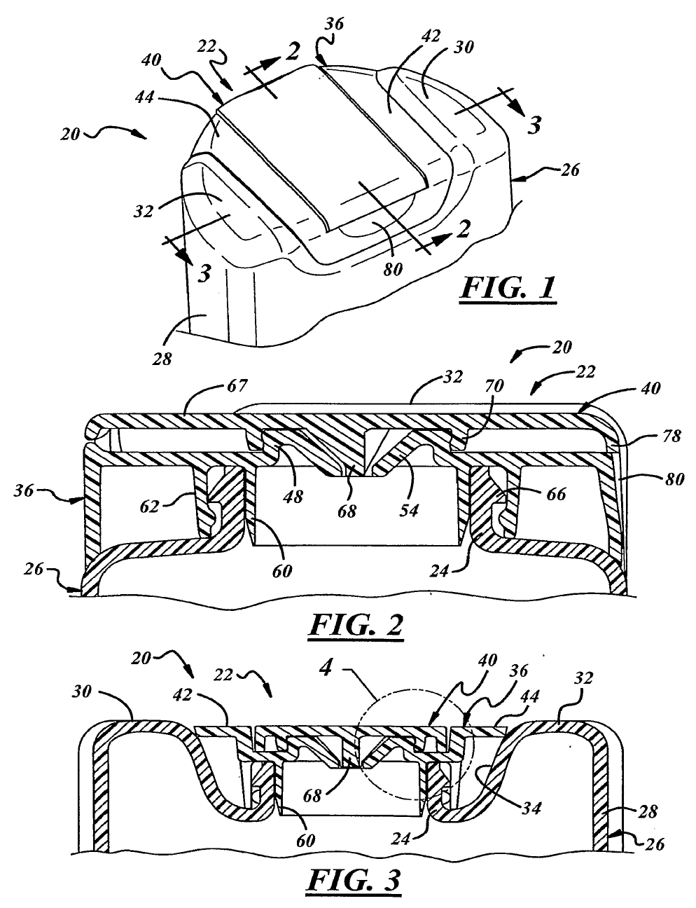

FIGS. 1-4 illustrate a package 20 in accordance with an exemplary embodiment of the present disclosure. Package 20 includes a dispensing closure 22 secured to the neck finish 24 of a container 26. Container 26 preferably is of molded plastic construction. In the exemplary embodiment illustrated in FIGS. 1-4, container 26 has a body 28 with a pair of laterally spaced shoulders 30, 32. A channel or recess 34 extends between shoulders 30, 32 and neck finish 24 is disposed within recess 34.

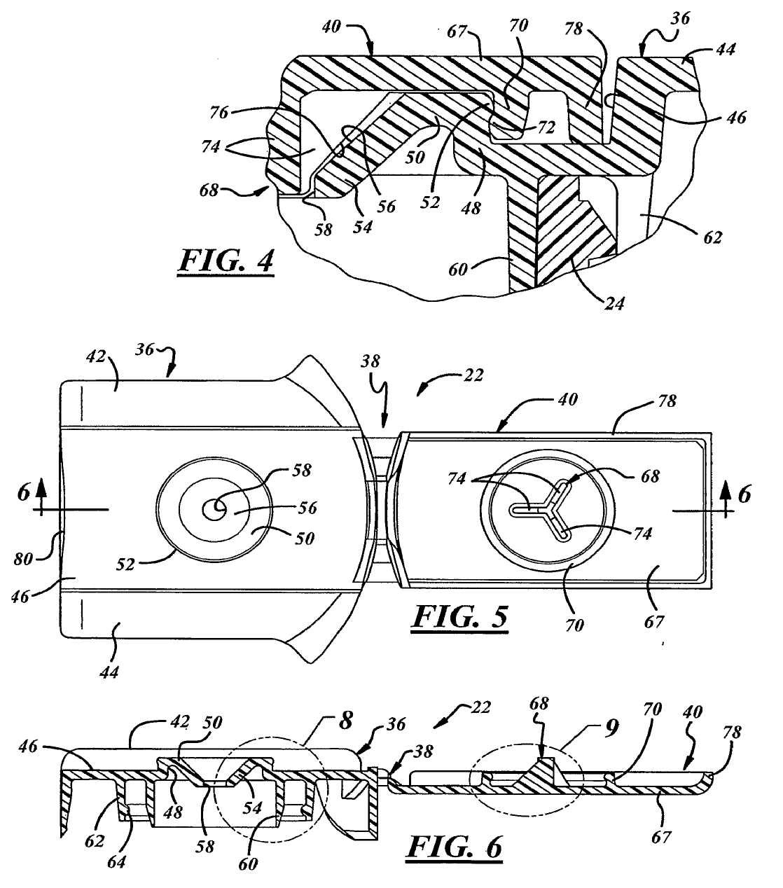

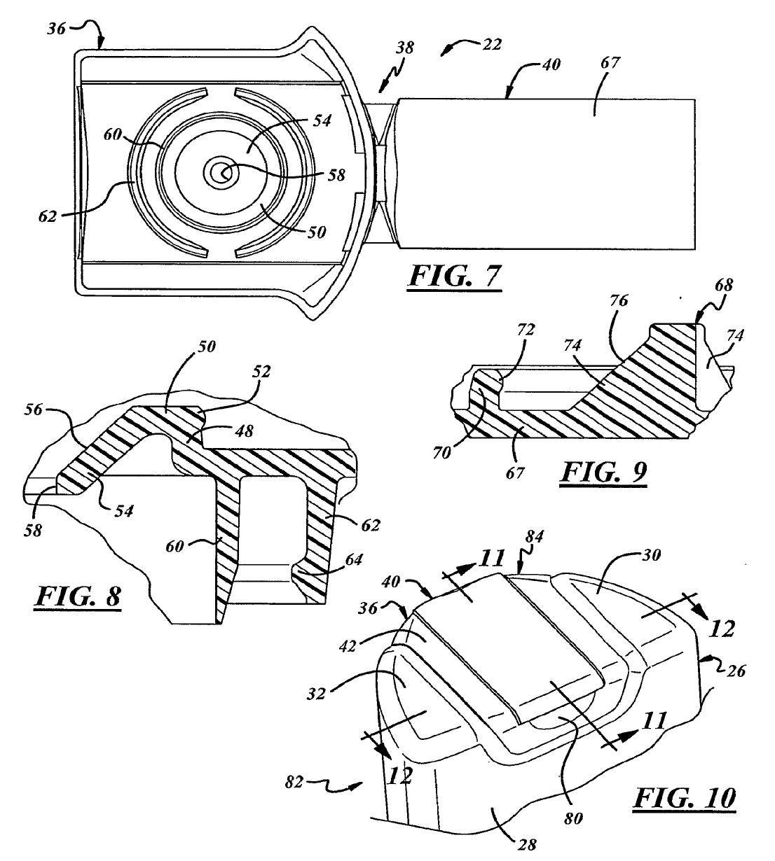

Closure 22 is illustrated in detail in FIGS. 5-9, and preferably is of one-piece integrally molded plastic construction including a base 36 connected by a hinge 38 to a lid 40. Hinge 38 illustrated in the drawings is of the type disclosed in U.S. Pat. No. 6,041,477. Other types of hinges can be employed. Base 36 in the exemplary embodiment of FIGS. 5-9 includes a pair of laterally spaced shoulders 42, 44 separated from each other by a recess or channel 46. An annular wall 48 extends from the top surface of recess 46 and a deck 50 is carried by annular wall 48. A circumferentially continuous first snap/seal bead 52 faces radially outwardly from wall 48 adjacent to the upper surface of deck 50. A wall 54 extends radially inwardly from deck 50 and has a radially inwardly and axially outwardly facing conical surface 56 that extends from the upper surface of deck 50 to a dispensing opening 58. Dispensing opening 58 preferably is circular, although other geometries can be employed. A dispensing valve can be positioned within the dispensing opening. In the exemplary embodiment of FIGS. 1-9, an annular wall 60 extends from the lower or inside surface of recess 46 for plug-sealing engagement within neck finish 24. A segmented annular wall 62 extends from the lower or inside surface of recess 46 and has a segmented internal bead 64 for snap-receipt over an external bead 66 on container neck finish 24. Other means of closure attachment can be employed.

Lid 40 is contoured for receipt within recess 46 of base 36 in the closed position of the lid illustrated in FIGS. 1-4. In this closed position in the exemplary embodiment of FIGS. 1-9, the upper or outer surface of lid base wall 67, which is substantially flat, preferably is substantially flush with the upper or outer surface of base shoulders 42, 44. The upper or outer surfaces of lid 40 and shoulders 42, 44 may be substantially flush with or recessed slightly below the upper surfaces of container shoulders 30, 32, as best seen in FIG. 3. Lid 40 has a spud or pintle 68 surrounded by an annular wall 70. Annular wall 70 has a radially inwardly facing circumferentially continuous second snap/seal bead 72 contoured to be received by snap-fit over bead 52 on wall 48 adjacent to deck 50 in the closed position of the lid. Pintle 68 in the embodiment of FIGS. 1-9 includes a plurality of angularly spaced radially extending ribs 74. Each rib 74 has an angulated outer surface 76 that is adapted to engage surface 56 that extends between deck 50 and dispensing opening 58 to center the pintle, and thereby center the lid, with respect to the dispensing opening as the lid is moved toward its closed position. One of the ribs 74 preferably extends toward hinge 38 to engage surface 56 and pull lid 40 away from hinge 38 as the lid is closed. However, as best seen in FIG. 4, the outer surfaces of pintle 68 preferably do not engage opposing surface 56 or dispensing opening 58 in the fully closed position of the lid. Rather, the lid is held in the closed position and is sealed with respect to the base by snap engagement of internal bead 72 on lid 40 over external bead 52 on base 36. The centering action provided by pintle 68 and surface 56 helps prevent end-to-end engagement that might otherwise occur between wall 70 and deck 50 as the lid is closed, which in turn helps facilitate in-mold closing of the lid over the base. That is, pintle 68 is sufficiently long as compared with wall 70 to engage surface 56 on base 36 and center lid 40 with respect to the base prior to engagement of beads 52, 72 on walls 48, 70.

A flange 78 extends from the periphery of lid 40 for engaging the opposing surface of recess 46 in the fully closed position of the lid, as best seen in FIGS. 2 and 3. In the exemplary embodiment illustrated in FIGS. 1-9, base 36 has an outer recess 80 (FIGS. 1-2 and 5), within which a user's thumb can engage the opposing edge of flange 78 to open the lid with respect to the base. Other lid opening arrangements could be employed. Indeed, a child-resistant latch can be provided between lid 40 and base 36, such as a latch of the type disclosed in U.S. patent document 2005/0023285 for example.

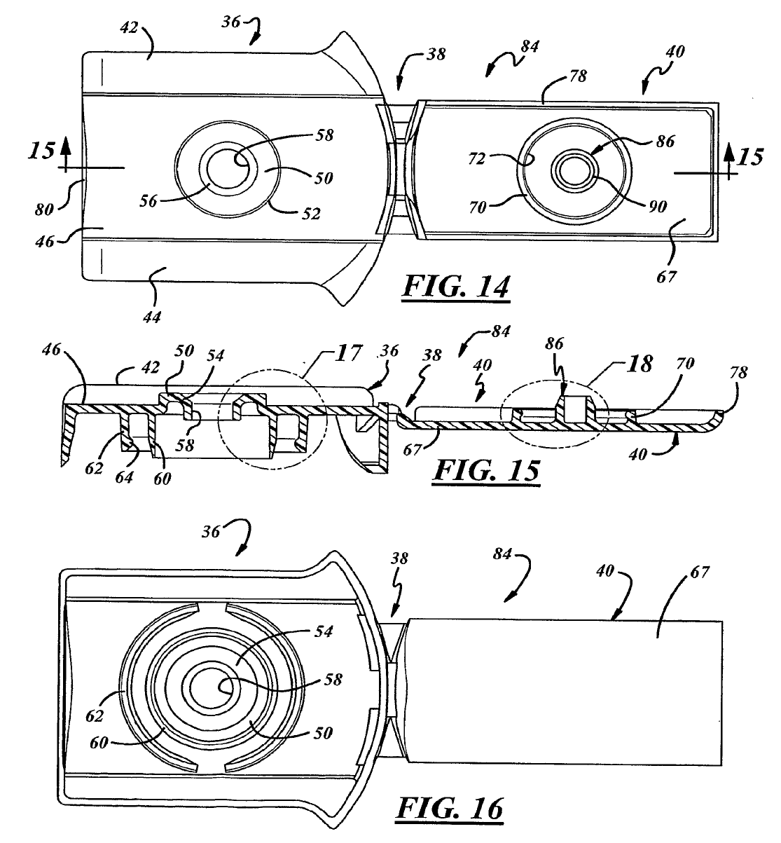

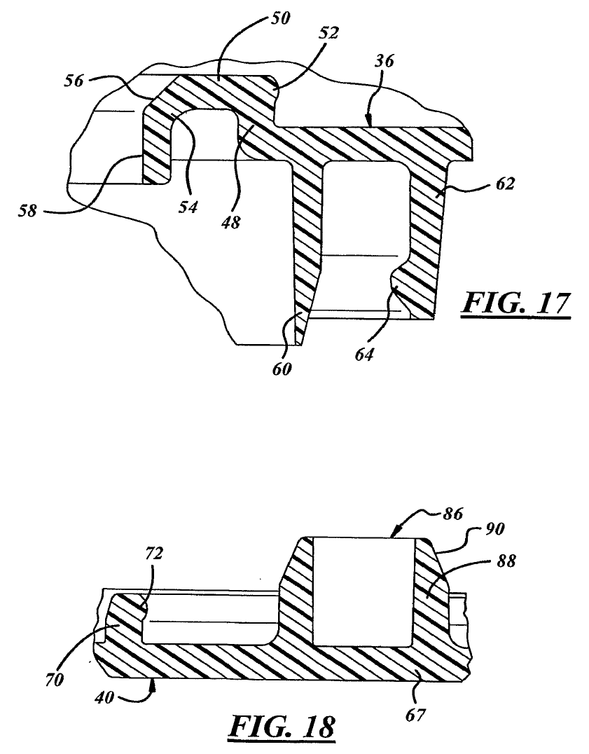

FIGS. 10-18 illustrate a package 82 in accordance with a second exemplary embodiment of the disclosure. Package 82 includes a closure 84 secured to a container 26. Elements of package 82 and closure 84 that are the same as or similar to corresponding elements in package 20 and closure 22 of FIGS. 1-9 are indicated by correspondingly identical reference numerals. The primary difference between closure 84 in FIGS. 10-18 and closure 22 in FIGS. 1-9 is in the construction of pintle 86 on lid 40. In closure 84, pintle 86 includes an annular wall 88 with a radially outwardly and axially outwardly facing conical surface 90 at the end of wall 88 remote from the base wall 67 of lid 40. This conical surface 90 cooperates with surface 56 that extends from deck 50 on closure base 36 to align the lid with the base as the lid is closed and prior to engagement of internal snap bead 72 on lid 40 with external snap bead 52 on base 36. That is, pintle 86 is sufficiently long as compared with wall 70 to engage surface 56 on base 36 and center lid 40 with respect to the base prior to engagement of beads 52, 72 on walls 48, 70. As in the embodiment of FIGS. 1-9, pintle 86 in the embodiment of FIGS. 10-18 serves to align and center lid 40 with respect to base 36 as the lid is closed, but not to seal the dispensing opening 58. Rather, the function of sealing the lid with respect to the base and the function of holding the lid in the closed are served by engaged snap/seal beads 52 72.

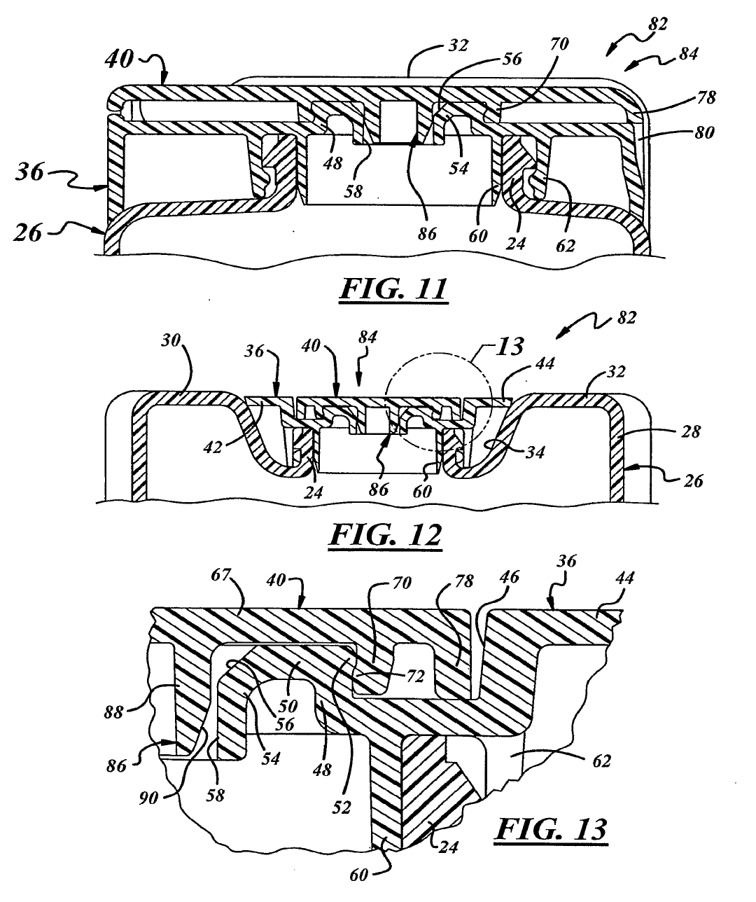

As noted above, it is preferred that the outside surface of pintle 68 or 86 be spaced from inside surface 56 and the inner edge of the dispensing opening (i.e., the dispensing passage) in the fully closed position of the lid. In applications in which the lid is closed in the forming mold, contact between the pintle and the dispensing passage can shave off small pieces of plastic material that, over millions of mold cycles, could become problematic. However, pintle 86 in FIGS. 11-13 could be made to provide a supplemental seal if desired. It also is preferred that pintle 68 or 86 not extend out of the bottom of the dispensing opening in the fully closed position of the lid, as shown in FIGS. 2-4 and 11-13. If the pintle were to extend out of the dispensing passage, the lid could not be closed in the forming mold. However, the pintle extends into the dispensing passage sufficiently to perform the alignment function discussed above and to punch our any dried product in the dispensing opening.

There thus have been disclosed a dispensing closure, a closure and container package and a method of making a dispensing closure that fully satisfy all of the objects and aims previously set forth. The disclosure has been presented in conjunction with exemplary embodiments of the disclosure, and additional modifications and variations have been discussed. Other modifications and variations readily will suggest themselves to persons of ordinary skill in the art in view of the foregoing discussion. The disclosure is intended to embrace all such modifications and variations as fall within the spirit and broad scope of the appended claims.

1. A dispensing closure that includes a base and a lid of one-piece integrally molded plastic construction, said lid being hinged to said base for movement between an open position spaced from said base and a closed position overlying said base,
said base having a deck with an outer surface, a dispensing opening, a radially inwardly and axially outwardly facing conical surface extending from said dispensing opening to said outer surface of said deck surrounding said dispensing opening, and a radially outwardly facing first snap/seal bead surrounding said deck adjacent to said outer surface,
said lid having a pintle for receipt in said dispensing opening, a wall spaced radially outwardly from said pintle and a radially inwardly facing second snap/seal bead on said wall for engagement with said first snap/seal bead on said base,
said pintle being sufficiently long as compared to said wall to engage said conical surface and align said beads prior to engagement of said beads as said lid is moved toward said closed position, said second bead on said lid being received by sealing snap fit over said first bead on said base.

2. The closure set forth in claim 1 wherein said pintle is spaced from an inner periphery of said dispensing opening in said closed position of said lid.

3. The closure set forth in claim 1 wherein said pintle does not extend through said dispensing opening in said closed position of the said lid.

4. The closure set forth in claim 1 wherein said pintle includes a plurality of angularly spaced ribs, with one of said ribs extending toward a hinge that connects said lid to said base.

5. The closure set forth in claim 1 wherein said base includes a pair of spaced shoulders and a recess between said shoulders, said deck and said dispensing opening being disposed within said recess, and said lid is disposed within said recess in said closed position of said lid and substantially flush with said shoulders.

6. The closure set forth in claim 3 wherein said deck is raised from said recess by an annular wall, said first snap/seal bead being disposed on said annular wall.

7. A dispensing closure that includes a base and a lid of one-piece integrally molded plastic construction, said lid being hinged to said base for movement between an open position spaced from said base and a closed position overlying said base,
said base having a deck with an outer surface, a dispensing opening, a radially inwardly and axially outwardly facing conical surface extending from said dispensing opening to said outer surface of said deck surrounding said dispensing opening, and a radially outwardly facing first snap/seal bead surrounding said deck adjacent to said outer surface,
said lid having a pintle for receipt in said dispensing opening, a wall spaced radially outwardly from said pintle and a radially inwardly facing second snap/seal bead on said wall for engagement with said first snap/seal bead on said base,
said pintle being sufficiently long as compared to said wall to engage said conical surface and align said beads prior to engagement of said beads as said lid is moved toward said closed position, said second bead on said lid being received by sealing snap fit over said first bead on said base,
said pintle being spaced from an inner periphery of said dispensing opening in said closed position of said lid and said pintle not extending completely through said dispensing opening in said closed position of said lid.

8. The closure set forth in claim 7 wherein said pintle includes a plurality of angularly spaced ribs, with one of said ribs extending toward a hinge that connects said lid to said base.

9. The closure set forth in claim 7 wherein said pintle comprises an annular wall.

10. A package that includes a container having a neck finish and a dispensing closure disposed on said neck finish,
said dispensing closure including a base and a lid of one-piece integrally molded plastic construction, said lid being hinged to said base for movement between an open position spaced from said base and a closed position overlying said base,
said base having a deck with an outer surface, a dispensing opening, a radially inwardly and axially outwardly facing conical surface extending from said dispensing opening to said outer surface of said deck surrounding said dispensing opening, and a radially outwardly facing first snap/seal bead surrounding said deck adjacent to said outer surface,
said lid having a pintle for receipt in said dispensing opening, a wall spaced radially outwardly from said pintle and a radially inwardly facing second snap/seal bead on said wall for engagement with said first snap/seal bead on said base,
said pintle being sufficiently long as compared to said wall to engage said conical surface and align said beads prior to engagement of said beads as said lid is moved toward said closed position, said second bead on said lid being received by sealing snap fit over said first bead on said base.

11. The package set forth in claim 10 wherein said pintle is spaced from an inner periphery of said dispensing opening in said closed position of said lid.

12. The package set forth in claim 11 wherein said pintle does not extend through said dispensing opening in said closed position of the said lid.

13. The package set forth in claim 10 wherein said pintle includes a plurality of angularly spaced ribs, with one of said ribs extending toward a hinge that connects said lid to said base.

14. The package set forth in claim 10 wherein said pintle comprises an annular well.

15. The package set forth in claim 10 wherein said base includes a pair of spaced shoulders and a recess between said shoulders, said deck and said outlet dispensing opening being disposed within said recess, and said lid is disposed within said recess in said closed position of said lid and substantially flush with said shoulders.

16. The package set forth in claim 15 wherein said deck is raised from said recess by an annular wall, said first snap/seal bead being disposed on said annular wall.

17. The package set forth in claim 16 wherein said container includes a pair of spaced shoulders and a recess between said shoulders,
said neck finish being disposed within said channel on said container,
said shoulders on said base and said lid on said closure being substantially flush with said shoulders of said container in said closed position of said lid.

18. A method of making a dispensing closure that includes integrally molding a lid and a base of one-piece plastic construction, said lid being hinged to said base for movement between an open position spaced from said base and a closed position overlying said base,
said base having a deck with an outer surface, a dispensing opening, a radially inwardly and axially outwardly facing conical surface extending from said dispensing opening to said outer surface of said deck surrounding said dispensing opening, and a radially outwardly facing first snap/seal bead surrounding said deck adjacent to said outer surface,
said lid having a pintle for receipt in said dispensing opening, a wall spaced radially outwardly from said pintle and a radially inwardly facing second snap/seal bead on said wall for engagement with said first snap/seal bead on said base,
said pintle being sufficiently long as compared to said wall to engage said conical surface and align said beads prior to engagement of said beads as said lid is moved toward said closed position, said second bead on said lid being received by sealing snap fit over said first bead on said base.

19. The method set forth in claim 18 including moving said lid to said closed position within the forming mold for said closure.

20. The method set forth in claim 19 wherein said pintle does not extend through said dispensing opening in said closed position of the said lid.

21. The method set forth in claim 20 wherein said pintle is spaced from an inner periphery of said dispensing opening in said closed position of said lid.
